(19) United States
(12) Patent Application Publication
(10) Pub. No.: US 2009/0006092 A1
(43) Pub. Date: Jan. 1, 2009

(54) Speech Recognition Language Model Making System, Method, and Program, and Speech Recognition System

(75) Inventors: Kiyokazu Miki, Tokyo (JP); Kentarou Nagamoto, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 12/087,869

(22) PCT Filed: Dec. 26, 2006
(86) PCT No.: PCT/JP2006/325907

§ 371 Date: Jul. 16, 2008

(30) Foreign Application Priority Data
Jan. 23, 2006 (JP) 2006-014273

(51) Int. Cl. G10L 15/06

(52) U.S. Cl. 704/244; 704/E15.001

(57) ABSTRACT

[PROBLEMS] To provide a speech recognition language model making system for making a speech recognition language model so as to recognize a meaningful speech necessary for application of speech recognition, such as a speech in conversation at a call center.

[MEANS FOR SOLVING PROBLEMS] A speech recognition language model making system (1) comprises a probability estimating device (11), a language model learning corpus storage device (14), and a learning corpus emphasizing device (12). The learning corpus emphasizing device (12) emphasizes a prescribed part of the learning corpus to create an emphasized learning corpus. The probability estimating device (11) operates to make a speech recognition language model by estimating the probability value of a language model by the emphasized learning corpus.

### TECHNICAL FIELD

The present invention relates to a speech recognition language model making system, a speech recognition language model making method, and a speech recognition language model making program. More specifically, the present invention relates to a speech recognition language model making system, a speech recognition language model making method, and a speech recognition language model making program for making a language model for enabling accurate recognition of a characteristic part other than a hash part such as a responding word part, when recognizing a speech of a spoken language.

### RELATED ART

An example of a traditional speech recognition language model making method is depicted in Non-Patent Document 1. As shown in FIG. 7, this traditional speech recognition language model making method is configured with a language model learning corpus storage part 302 for storing a learning corpus for estimating probability of N-gram, and a probability estimating device 301 for estimating the probability of the N-gram based thereupon.

A traditional speech recognition language model making system 300 having such constituents operates as follows. The appearance number of the N-gram is obtained from the learning corpus stored in the language model learning corpus storage part 302, and the probability estimating device 301 performs a maximum likelihood estimation of the probability of the N-gram according to Expression 1.

$$P ( {w}_{n} \vert \begin{matrix}{w}_{n - N + 1} & … & {w}_{n - 1}\end{matrix} ) = \frac{C ( \begin{matrix}{w}_{n - N + 1} & … & {w}_{n}\end{matrix} )}{C ( \begin{matrix}{w}_{n - N + 1} & … & {w}_{n - 1}\end{matrix} )} \qquad Expression 1$$

In Expression 1, P(wₙ|w_{n-N+1} - - - Wₙ₋₁) is the probability of the N-gram, and C(wᵢ - - - wᵢ₊ₖ) is the appearance number of word string wᵢ - - - wᵢ₊ₖ in the learning corpus

NON-Patent Document 1: “Speech Language Processing”, pp. 27-28, Kenji KITA, Satoshi NAKAMURA, Masaaki NAGATA, Nov. 15, 1996 Morikita Publishing Co., Ltd.

### DISCLOSURE OF THE INVENTION

However, there are some issues in the traditional speech recognition language model making method. A first issue is that a value of the probability for hash expressions becomes unnecessarily significant with a language model that is made by the traditional speech recognition language model making method, in a case where a text that is written from a spoken language (e.g., a conversation taken place at a call center) where an extremely large number of hash expressions such as responding words “yes”, “yeah”, fillers “well”, “er”, “uh”, polite but redundant ending words in Japanese such as “gozaimasu”, “itadakimasu” appears is used to be the language model learning corpus. When speech recognition using such language model is applied, a meaningful key speech may be misrecognized as a hash expression.

A second issue is that it is difficult to obtain a language model with which a part (that needs to pay serious attention) of speech data can be recognized accurately. It is because contents of phonation as targets of speech recognition vary, and it is difficult to grasp the contents themselves and tendency thereof in advance.

It is an object of the present invention to provide a speech recognition language model making system capable of making a speech recognition language model that enables a speech necessary when being applied to speech recognition to be recognized accurately, when recognizing speech data of a spoken language that is taken place at a call center or the like.

A speech recognition language model making system according to the present invention comprises a probability estimating device, a language model learning corpus storage device, and a learning corpus emphasizing device, wherein: the learning corpus emphasizing device operates to create an emphasized learning corpus by emphasizing a prescribed part in a learning corpus; and the probability estimating device operates to estimate a probability value of a language model according to the emphasized learning corpus to create a speech recognition language model. Note here that “to emphasize the prescribed part in the learning corpus” is to increase prescribed part in the learning corpus, or to increase a proportion of the prescribed part occupying the entire learning corpus by reducing the parts other than the prescribed part.

By employing such structure, it becomes possible to create the speech recognition language model capable of accurately recognizing a key word that is necessary when being applied to the speech recognition, through emphasizing the meaningful part in the corpus when crating a language model by using the corpus that is a text written from a spoken language such as a conversation taken place at a call center or the like, which contains many responding words, fillers, and the like, or from a spoken language that is more patterned and has many similar parts in each conversation so that a difference between each of the conversations is a critical part.

The speech recognition language model making system described above may include an emphasis part extracting device for extracting a prescribed part from the learning corpus, wherein the learning corpus emphasizing device creates an emphasized learning corpus in which the part extracted by the emphasis part extracting device is emphasized. With this, the emphasized learning corpus can be created automatically without using an operator to set the part that needs to pay a serious attention.

In the speech recognition language model making system described above, the emphasis part extracting device may divide the learning corpus according to a prescribed criterion to create divided learning corpuses and extract a characteristic part from each of the divided learning corpuses, and the learning corpus emphasizing device may create the emphasized learning corpus by emphasizing the part extracted by the emphasis part extracting device. Note here that “characteristic part” is a meaningful part that is necessary when being applied to speech recognition. With this, it is possible to extract the part to be emphasized, in accordance with the characteristic of the divided learning corpus.

With the speech recognition language model making system described above, as a method for extracting the characteristic part, the emphasis part extracting device may conduct selection according to a tf-idf value that quantitatively shows whether or not a certain word contained in the corpus is a characteristic part. This makes it possible to extract a characteristic part that often appears in the divided learning corpuses and does not appear often in the divided learning corpuses other than the concerned divided learning corpus.

In the speech recognition language model making system describe above, a unit of the part to be emphasized may be set as a sentence. With this, a sentence containing a part of the characteristic part can be extracted as a key sentence. Therefore, a part that is not judged as characteristic but important can be extracted without a fail.

In the speech recognition language model making system describe above, a unit of the part to be emphasized may be set as a phrase. This makes it possible to reduce an adverse effect generated by emphasizing a hash part that may be contained in a sentence in some cases when emphasis is placed by a unit of sentence.

A speech recognition system according to the present invention includes a speech recognition device which recognizes speech data by using a speech recognition language model that is obtained by the speech recognition language model making system described above. Such speech recognition system performs speech recognition by using a speech model that is created according to the learning corpus in which the key part is emphasized, so that it is possible to execute the speech recognition with higher accuracy than that of traditional speech recognition processing.

A speech recognition language model making method according to the present invention includes a learning corpus readout step, a probability estimating step, and a corpus emphasizing step, wherein: the corpus emphasizing step creates an emphasized learning corpus by emphasizing a prescribed part in a learning corpus that is read out from a storage unit; and the probability estimating step estimates a probability value of a language model according to the emphasized learning corpus to create a speech recognition language model.

By employing such method, it becomes possible to create the speech recognition language model capable of accurately recognizing an important word that is necessary when being applied to the speech recognition, through emphasizing the meaningful part in the corpus when crating a language model by using the corpus that is a text written from a spoken language such as a conversation taken place at a call center or the like, which contains many responding words, fillers, and the like, or from a spoken language that is more patterned and has many similar parts in each conversation so that a difference between each of the conversations is an important part.

The speech recognition language model making method described above may include an emphasis part extracting step for extracting a prescribed part from the learning corpus, wherein the learning corpus emphasizing step creates an emphasized learning corpus in which the part extracted in the emphasis part extracting step is emphasized. With this, the emphasized learning corpus can be created automatically without using an operator to set the part that needs to be paid a serious attention.

In the speech recognition language model making method described above, the emphasis part extracting step may divide the learning corpus according to a prescribed criterion to create divided learning corpuses and extract a characteristic part from each of the divided learning corpuses, and the learning corpus emphasizing step may create the emphasized learning corpus by emphasizing the part extracted by the emphasis part extracting step. With this, it is possible to extract the characteristic part, in accordance with the characteristic of the divided learning corpus.

With the speech recognition language model making method described above, as a method for extracting the characteristic part, the emphasis part extracting step may conduct selection according to a tf-idf value that quantitatively shows whether or not a certain word contained in the corpus is a characteristic part. This makes it possible to extract a characteristic part that often appears in the divided learning corpus and does not appear often in the divided learning corpuses other than the concerned divided learning corpus.

With the speech recognition language model making method describe above, a unit of the part to be emphasized may be set as a sentence.

With this, a sentence containing a part of the characteristic part can be extracted as a key sentence. Therefore, a part that is not judged as characteristic but important can be extracted without a fail.

With the speech recognition language model making method describe above, a unit of the part to be emphasized may be set as a phrase. This makes it possible to reduce an adverse effect generated by emphasizing a meaningless part that may be contained in a sentence in some cases when emphasis is placed by a unit of sentence.

A speech recognition language model making program according to the present invention enables a computer to execute: a learning corpus readout function which reads out a learning corpus from a storage unit; a corpus emphasizing function which emphasizes a prescribed part in the learning corpus to create an emphasized learning corpus; and a probability estimating function which estimates a probability value of the language model according to the emphasized learning corpus.

By enabling the computer to execute such program, it becomes possible to create the speech recognition language model capable of accurately recognizing a key word that is necessary when being applied to the speech recognition, through emphasizing the meaningful part in the corpus when crating a language model by using the corpus that is a text written from a spoken language such as a conversation taken place at a call center or the like, which contains many responding words, fillers, and the like, or from a spoken language that is more patterned and has many similar parts in each conversation so that a difference between each of the conversations is a critical part.

With the speech recognition language model making program described above, a emphasis part extracting function which extracts a prescribed part from the learning corpus may be executed by the computer, and the learning corpus emphasizing function may create the emphasized learning corpus by emphasizing the extracted part. With this, the emphasized learning corpus can be created automatically without using an operator to set the part that needs to be paid a serious attention.

With the speech recognition language model making program described above, the emphasis part extracting function may divide the learning corpus according to a prescribed criterion to create divided learning corpuses and extract a characteristic part from each of the divided learning corpuses, and the learning corpus emphasizing function may create the emphasized learning corpus by emphasizing the extracted part. With this, it is possible to extract the characteristic part in accordance with the characteristics of the divided learning corpuses.

With the speech recognition language model making program described above, as a method for extracting the characteristic part, the emphasis part extracting function may conduct selection according to a tf-idf value that quantitatively shows whether or not a certain word contained in the corpus is a characteristic part. This makes it possible to extract a characteristic part that often appears in the divided learning corpus and does not appear often in the divided learning corpuses other than the concerned divided learning corpus.

With the speech recognition language model making program describe above, a unit of the part to be emphasized may be set as a sentence. With this, a sentence containing a part of the characteristic part can be extracted as a key sentence. Therefore, a part that is not judged as characteristic but important can be extracted without a fail.

With the speech recognition language model making program describe above, a unit of the part to be emphasized may be set as a phrase. This makes it possible to reduce an adverse effect generated by emphasizing a hash part that may be contained in a sentence in some cases when emphasis is placed by a unit of sentence.

The effect of the present invention is that it is possible to create a speech recognition language model for achieving more accurate recognition of a meaningful speech that is necessary when being applied to speech recognition. The reason is that the learning corpus emphasizing device creates the emphasized learning corpus by emphasizing the key part in the learning corpus, and the probability estimating device estimates the probability value of the language model by using the emphasized learning corpus. Therefore, it is possible to create a speech recognition language model that is capable of more accurately recognizing the key word that is necessary when being applied to speech recognition.

### BEST MODES FOR CARRYING OUT THE INVENTION

Hereinafter, structures and operations of a speech recognition language model making system 1 as a first exemplary embodiment of the invention will be described by referring to the accompanying drawings.

FIG. 1 is a functional block diagram showing the structures of the speech recognition language model making system 1.

As shown in FIG. 1, the speech recognition language model making system 1 according to the first exemplary embodiment includes: a probability estimating device 11 for estimating N-gram probability as a language model for speech recognition; a learning corpus emphasizing device 12 for making an emphasized learning corpus in which a prescribed part in a learning corpus used for learning the language model is emphasized; an emphasis part extracting device 13 for extracting a characteristic part to be emphasized from the learning corpus; and a language model learning corpus storage device 14 for storing the learning corpus.

Here, to emphasize the prescribed part in the learning corpus is to increase prescribed part in the learning corpus, or to increase a proportion of the prescribed part occupying the entire learning corpus by reducing the parts other than the prescribed part.

The probability estimating device 11 estimates N-gram to be a language model for performing speech recognition based on the emphasized learning corpus that is made by the learning corpus emphasizing device 12. Specifically, as disclosed in Non-Patent Document 1, the appearance number of the N-gram in the emphasized learning corpus is obtained and a maximum likelihood estimation is performed to obtain the probability of the N-gram based on the appearance number of the N-gram by using Expression 1 described above.

The learning corpus emphasizing device 12 emphasizes the part extracted from the learning corpus stored in the language model learning corpus storage device 14 by the emphasis part extracting device 13 to create the emphasized learning corpus. For example, when a unit of the part to be emphasized is a sentence, the extracted sentence is copied for n-times (n is a natural number), which is a preset number, and adds the copies to the original learning corpus to create the emphasized learning corpus. As other methods for making the emphasized learning corpus, it is possible to use a method which increase the sentence extracted by the emphasis part extracting device 13 in proportion to a given parameter, or a method which cancels unextracted sentences from the learning corpus by a certain proportion or reduces the unextracted sentences in inverse proportion to a parameter given by the emphasis part extracting device 13. Further, those methods may be used in combination. Depending on presence of similar N-grams and words (particularly meaningless words) that may have a chance of being mixed up, extent of emphasis may be changed (e.g., may put great emphasis when there is a high risk of having mix-up). This is the same when the part to be emphasized is a short unit such as a phrase, word, or N-gram.

The emphasis part extracting device 13 creates divided learning corpuses by dividing the learning corpus stored in the language model learning corpus storage device 14 according to a prescribed criterion, calculates a tf-idf value that quantitatively shows whether or not a certain word contained in the divided learning corpus is a characteristic part of the divided learning corpus by using Expression 2 for each word, and selects and extracts characteristic parts of each divided learning corpus based on the tf-idf values of each word.

$$tfidf = \frac{C ( d , w )}{N ( d )} \times {log}_{2} \frac{{D}_{all}}{D ( w )} \qquad Expression 2$$

In Expression 2, w is a word to be considered, d is a document to be considered, C_{(d, w)} is the appearance number of the word w in the document d, N_{(d)} is a total word number of the document d, Dₐₗₗ is a total document number, and D_{(w)} is a number of documents that contain the word w. The first exemplary embodiment takes the document d as each of the divided learning corpuses.

As the criteria for dividing the learning corpus, there are criteria such as dividing it chronologically, dividing it evenly without a condition, etc. Further, when the learning corpus is written from a speech in a telephone conversation taken place at a call center, there are also criteria such as dividing it by each speaker, dividing it by each operator, dividing it by each telephone communication, dividing it by each inquired company, dividing it by each inquired department, etc.

As a method for selecting the characteristic part, when the unit of selected part is a sentence, there is a method which calculates the tf-idf value by using Expression 2 through having each of all the words configuring the sentence as w, and selects the sentence whose total value exceeds a certain value as the characteristic part. With such method, the targets for adding up the tf-idf values may be limited only to independent words or to a specific kind of words in the sentence. Further, the total of the tf-idf values may be divided by the number of the target words, or the total value may be divided by the number of the words that configure the sentence. With this, it is possible to extract the characteristic part which appears in the divided learning corpus often and does not often appear in the divided learning corpuses other than the concerned divided learning corpus.

Further, it is the same for a case where the unit of the selected parts is a phrase, word, or N-gram. By setting the unit of the selected parts still smaller, it is possible to reduce an adverse effect generated by emphasizing a hash part that may be contained in the sentence in some cases when emphasis is placed by a unit of sentence. Further, the unit of the selected part may be set as a class that contains a plurality of words. An example of the class may be kinds of words, or the like.

As the criteria for extracting the characteristic part, it is possible to use a value that is not divided by N(d) in a first term of the right side of Expression 1 or a value obtained by constant multiplication of the first term and a second term on the right side of Expression 1 by different values from each other, other than using the tf-idf values. Further, values such as mutual information amount and relative frequency may be used instead of the tf-idf values. Furthermore, it may be structured to extract a part selected by a user as the characteristic part according to an input operation performed by the user.

Further, the emphasis part extracting device 13 may output the tf-idf value and the like used as the criterion for extracting the characteristic part to the learning corpus emphasizing device 12 as parameters.

The language model learning corpus storage device 14 stores the learning corpus used for learning the language model. The learning corpus is a text divided into units for speech recognition. Further, information for the emphasis part extracting device 13 to divide the learning corpus is added to the learning corpus. For example, speaker identifying information and the like for dividing the learning corpus by each speaker is added to the learning corpus.

Next, the entire operation of the speech recognition language model making system 1 will be described in detail by referring to flowcharts shown in FIG. 2 and FIG. 3.

FIG. 2 is a flowchart showing the operation when the emphasis part extracting device 13 divides the learning corpus stored in the language model learning corpus storage device 14 by each speaker.

First, the emphasis part extracting device 13 divides the learning corpus stored in the language model learning corpus storage device 14 into n-pieces (n is a natural number) of divided learning corpuses by a method determined in advance (S101 of FIG. 2).

FIG. 6A is a schematic illustration showing a data structure of each divided learning corpus. A divided learning corpus 15 is configured with M-pieces (M is a natural number) of sentences, i.e., a sentence 1 to a sentence M. Each of the sentence 1 to M contains a plurality of words.

Subsequently, the emphasis part extracting device 13 calculates the tf-idf values of the word units for each divided learning corpus by using Expression 2 (S102), and calculates the tf-idf values of each of the sentences 1−M from the total value of the tf-idf values of the word units contained in each sentence (S103-S105). Then, the emphasis part extracting device 13 judges whether the tf-idf values of each sentence are equal to or higher than a predetermined threshold value (S106), and extracts the sentence whose tf-idf value is equal to or higher than the threshold value as the characteristic part.

The learning corpus emphasizing device 12 copies the extracted sentence for a preset number m (m is a natural number), and adds the copies to the original learning corpus to create the divided learning corpus where the characteristic part is emphasized (S107). For example, when the tf-idf value of the sentence 3 in FIG. 6A is equal to or higher than the threshold value, m-pieces of copies thereof are added between the sentence 3 and the sentence 4. With this, an emphasized divided learning corpus 16 becomes as in FIG. 6B. As described, the characteristic part can be emphasized when the proportion of the number (m+1) of the sentence 3 as the characteristic part for M is increased than that of the case shown in FIG. 6A. Subsequently, the learning corpus emphasizing device 12 combines the n-pieces (n is a natural number) of divided learning corpuses in which the characteristic part is emphasized into one to create the emphasized learning corpus (S108). The probability estimating device 11 estimates the N-gram probability from the emphasized learning corpus, and obtains the language model for speech recognition.

FIG. 3 shows details of the method for obtaining the tf-idf values of the word units (S102 of FIG. 2).

First, the emphasis part extracting device 13 divides the learning corpus stored in the language model learning corpus storage device 14 into n-pieces (n is a natural number) of divided learning corpuses by a method determined in advance (S101 of FIG. 3).

The emphasis part extracting device 13 calculates the appearance number C_{(d, w)} of a single word within the divided learning corpuses for all the words (w₁−w_{N}, N is the total number of words contained in the divided learning corpuses) contained in each of the divided learning corpuses (S203 of FIG. 3), and calculates the number D_{(w)} of the divided learning corpuses containing that word (S204 of FIG. 3). The tf-idf value of the word unit shown with Expression 2 can be obtained in this manner.

FIG. 4 is a functional block diagram when the speech recognition language model making system 1 described above is achieved by a computer 20.

The computer 20 includes a CPU (Central Processing Unit) 21, a main storage unit 22 that is configured with a RAM (Random Access Memory), for example, an input/output interface 23, and an external storage unit 24 that is configured with a hard disk device, for example.

Stored in the external storage unit 24 are a language model learning corpus 26, and a speech recognition language model making program 24 which is executed by the CPU 21 to operate each piece of hardware of the computer 20 as the probability estimating device 11, the learning corpus emphasizing device 12, and the emphasis part extracting device 13 shown in FIG. 1.

The computer 20 operates as the speech recognition language model making system 1 when the speech recognition language model making program 24 is loaded to the main storage unit 22, and the CPU 21 executes the program 24.

The speech recognition language model making system 1 according to the first exemplary embodiment selects the characteristic part according to the criterion specified in advance to create the learning corpus in which the selected part is emphasized. However, the way of creating the emphasized learning corpus is not limited to that. It is also possible to perform speech recognition, select the characteristic part according to the result thereof, and adjust emphasis/suppression.

Next, effects of the speech recognition language model making system 1 according to the first exemplary embodiment will be described. The speech recognition language model making system 1 is so structured that: the emphasis part extracting device 13 selects and extracts the part to be emphasized from the learning corpus stored in the language model learning corpus storage device 14; the learning corpus emphasizing device 12 emphasizes the extracted part to create the emphasized learning corpus; and the probability estimating device 11 creates the language model by using the emphasized learning corpus. Therefore, it is possible to create the speech recognition language model capable of accurately recognizing a key word that is necessary when being applied to the speech recognition.

FIG. 5 is a functional block diagram of a speech recognition system 30 as a second exemplary embodiment of the invention.

The speech recognition system 30 includes a speech storage device 31, a speech recognition device 32, a recognition result storage device 33, and a language model storage device 34.

The speech storage device 31 stores the speech data to be a target of speech recognition. The speech data is digitized data obtained by sampling analog speech signals with a prescribed sampling frequency and quantizing each sampling value, for example.

The speech recognition device 32 recognizes the speech data loaded from the speech storage device 31 by using a speech model stored in the language model storage device 34, and outputs the recognition result to the recognition result storage device 33 as text data. The recognition result storage device 33 stores the text data that is the recognition result of the speech data.

The speech recognition language model stored in the language model storage device 34 is created by the probability estimating device 11 of the speech recognition language model making system 1 shown in FIG. 1 through estimating the probability from the emphasized learning corpus.

Such speech recognition system 30 performs speech recognition by using the speech recognition speech model that is created based on the emphasized learning corpus. Therefore, it is possible to improve the accuracy of speech recognition compared to the case of using the traditional speech model.

### INDUSTRIAL APPLICABILITY

The present invention can be applied to a speech recognition apparatus for recognizing speeches, a program for achieving speech recognition by a computer, and the like.

### BRIEF DESCRIPTION OF THE DRAWINGS

FIG. 1 is a block diagram showing structures of a speech recognition language model making system as a first exemplary embodiment of the invention;

FIG. 2 is a flowchart showing operations of the speech recognition language model making system;

FIG. 3 is a flowchart showing operations of the speech recognition language model making system;

FIG. 4 is a block diagram showing a case of achieving the speech recognition language model making system by a computer;

FIG. 5 is a block diagram showing structures of a speech recognition system as a second exemplary embodiment of the invention;

FIG. 6A is an illustration showing an example of a data structure of a divided learning corpus before placing emphasis;

FIG. 6B is an illustration showing an example of a data structure of the divided leaning corpus after placing emphasis; and

FIG. 7 is a diagram showing structures of a traditional speech recognition language model making system.

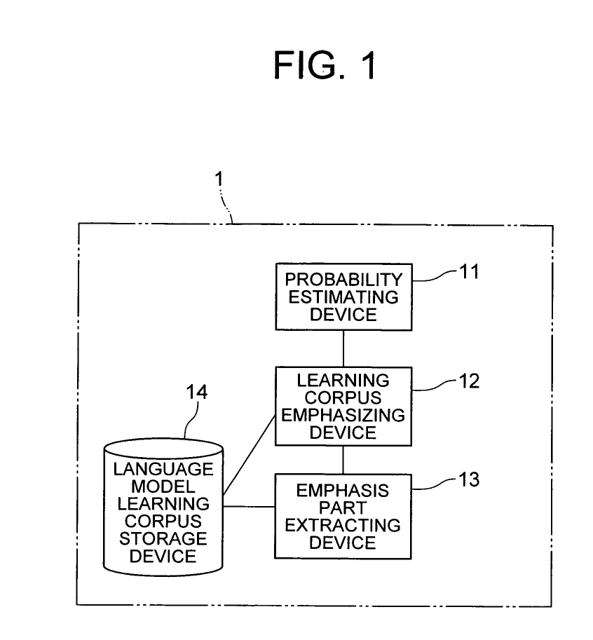

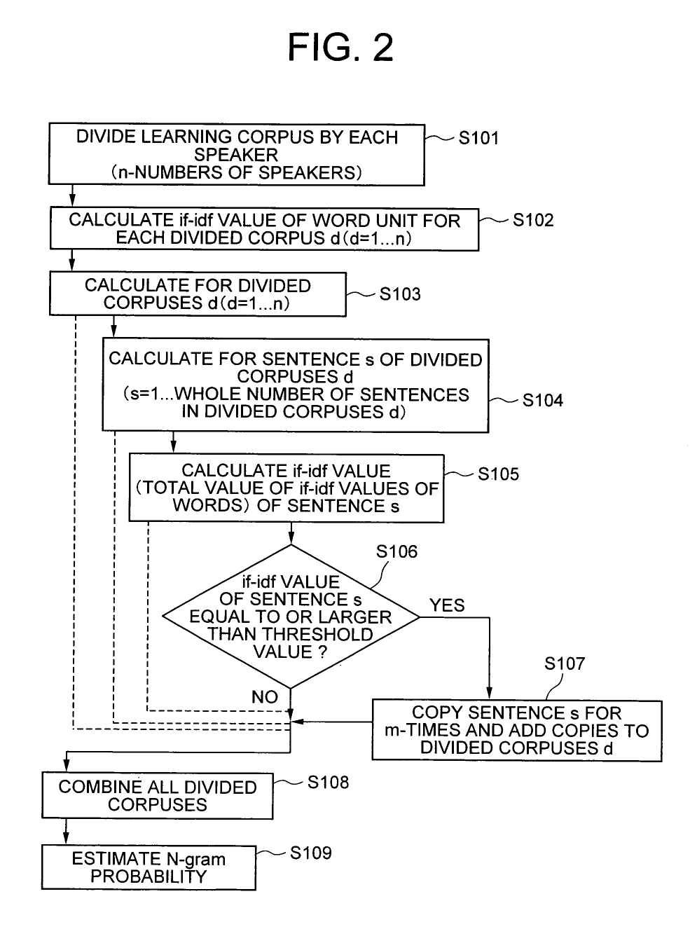

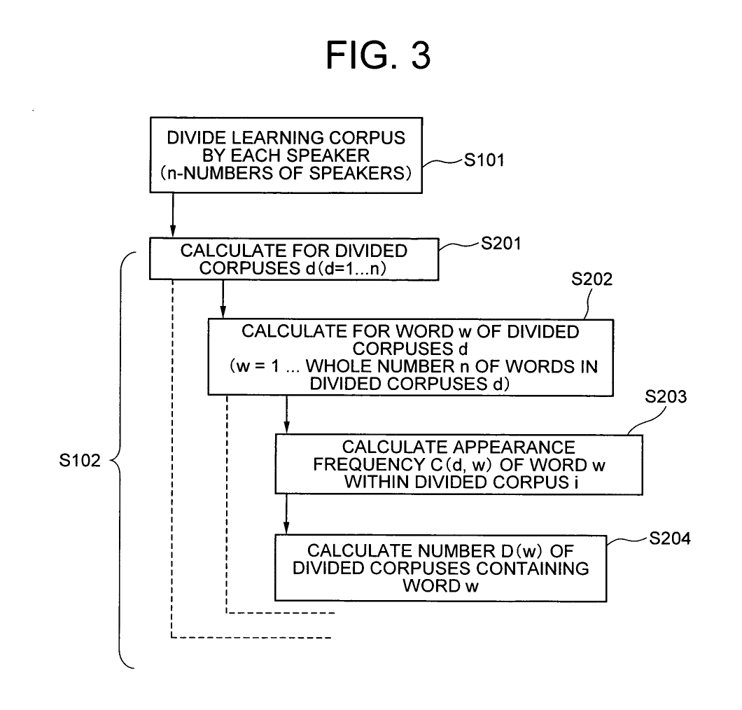

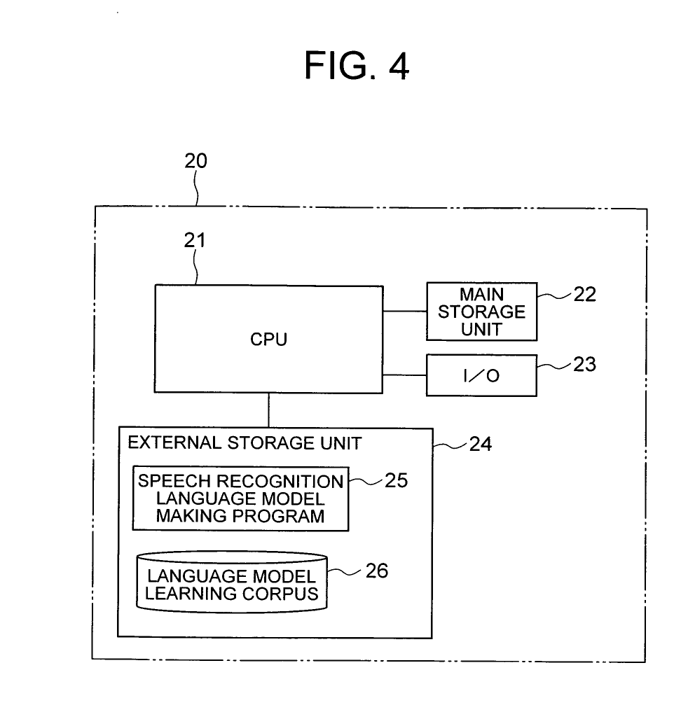

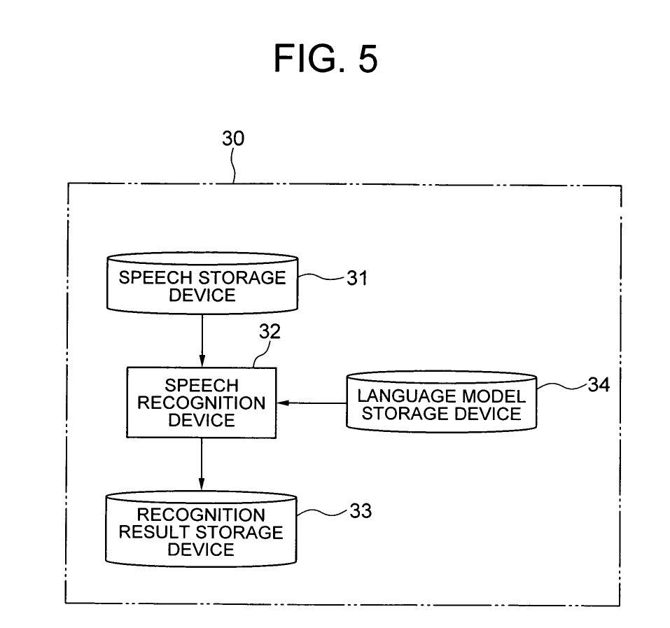

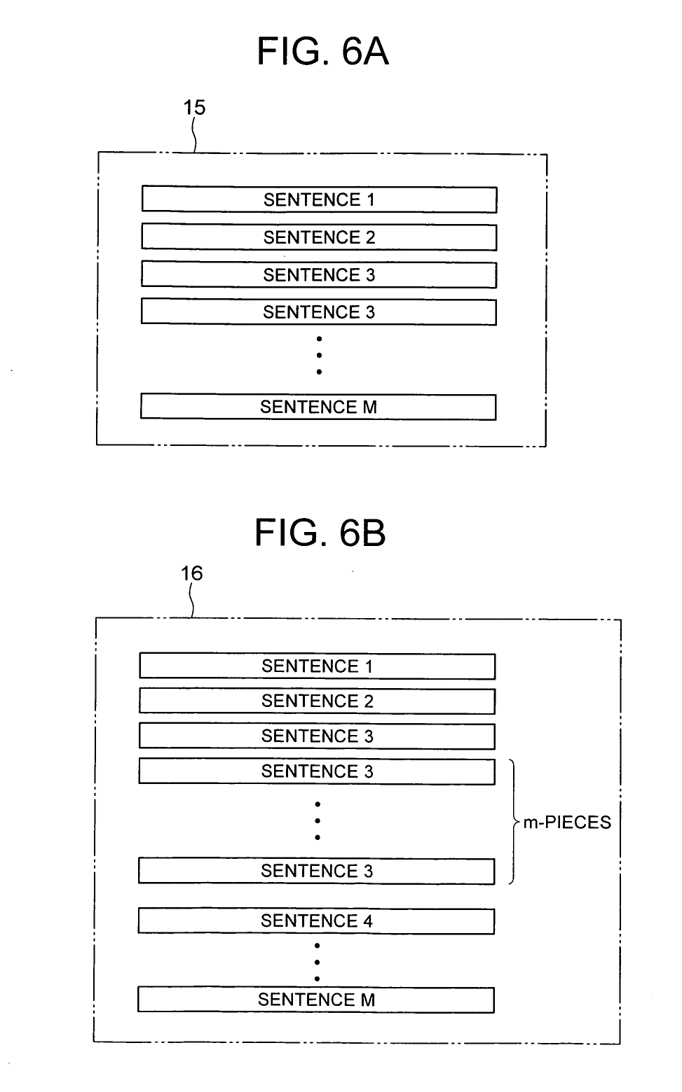

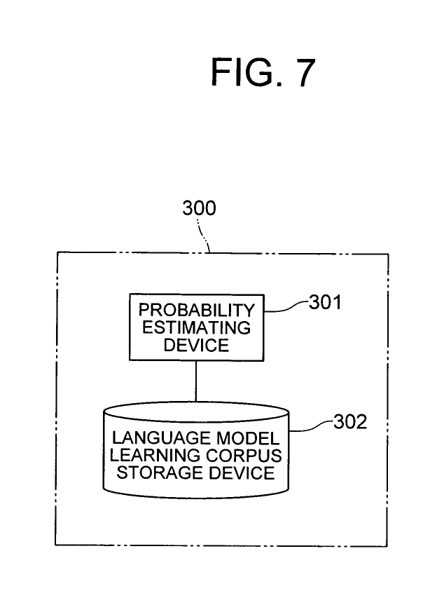

### REFERENCE NUMERALS

1 Speech recognition language model making system
11 Probability estimating device
12 Learning corpus emphasizing device
13 Emphasis part extracting device
14 Language model learning corpus storage device
15 Divided learning corpus
16 Emphasized divided learning corpus
20 Computer
21 CPU
22 Main storage unit
23 Input/output interface
24 External storage unit
25 Speech recognition language model making program
26 Language model learning corpus
30 Speech recognition system
31 Speech storage device
32 Speech recognition device
33 Recognition result storage device
34 Language model storage device
300 Speech recognition language model making system
301 Probability estimating device
302 Language model learning corpus storage device

1-19. (canceled)

20. A speech recognition language model making system, comprising:
a language model learning corpus storage device for storing a learning corpus used for learning a speech recognition language model;
an emphasis part extracting device for extracting a characteristic part of the learning corpus according to a value calculated from the learning corpus that is stored in the learning corpus storage device;
a learning corpus emphasizing device for creating an emphasized learning corpus in which the part extracted by the emphasis part extracting device is emphasized; and
a probability estimating device for estimating a probability value of the language model according to the emphasized learning corpus created by the learning corpus emphasizing device.

21. The speech recognition language model making system as claimed in claim 20, wherein the emphasis part extracting device divides the learning corpus, and extracts a characteristic part from each of the divided learning corpuses.

22. The speech recognition language model making system as claimed in claim 21, wherein the emphasis part extracting device extracts the characteristic part for each of the divided learning corpuses according to a tf-idf value that is a criterion for extracting the characteristic part of the learning corpus.

23. The speech recognition language model making system as claimed in claim 20, wherein the emphasis part extracting device extracts the part to be extracted by a unit of sentence.

24. The speech recognition language model making system as claimed in claim 20, wherein the emphasis part extracting device extracts the part to be extracted by a unit of phrase.

25. A speech recognition system, including:
the speech recognition language model making system claimed in claim 20 for creating a speech recognition language model; and
a speech recognition device which recognizes speech data by using the speech recognition language model that is obtained by the speech recognition language model making system.

26. A speech recognition language model making system, comprising:
a language model learning corpus storage means for storing a learning corpus used for learning a speech recognition language model;
an emphasis part extracting means for extracting a characteristic part of the learning corpus according to a value calculated from the learning corpus that is stored in the learning corpus storage means;
a learning corpus emphasizing means for creating an emphasized learning corpus in which the part extracted by the emphasis part extracting means is emphasized; and
a probability estimating means for estimating a probability value of the language model according to the emphasized learning corpus created by the learning corpus emphasizing means.

27. A speech recognition language model making method, comprising:
extracting a characteristic part of a learning corpus according to a value that is calculated from the learning corpus used for learning a language model for speech recognition;
creating an emphasized learning corpus in which the part extracted at extracting the characteristic part of the learning corpus is emphasized; and
estimating a probability value of the language model according to the emphasized learning corpus that is created in creating the emphasized learning corpus.

28. The speech recognition language model making method as claimed in claim 27, wherein in extracting the characteristic part of the learning corpus, the learning corpus is divided, and the characteristic part is extracted from each of the divided learning corpuses.

29. The speech recognition language model making method as claimed in claim 28, wherein in extracting the characteristic part of the learning corpus, the characteristic part for each of the divided learning corpuses is extracted according to a tf-idf value that is an extraction criterion of the characteristic part of the learning corpus.

30. The speech recognition language model making method as claimed in claim 28, wherein in extracting the characteristic part of the learning corpus, the part to be extracted is extracted by a unit of sentence.

31. The speech recognition language model making method as claimed in claim 28, wherein in extracting the characteristic part of the learning corpus, the part to be extracted is extracted by a unit of phrase.

32. A speech recognition language model making program for enabling a computer to execute:
a function which extracts a characteristic part of a learning corpus according to a value that is calculated from the learning corpus used for learning a language model for speech recognition;
a function which creates an emphasized learning corpus in which the extracted part is emphasized; and
a function which estimates a probability value of the language model according to the emphasized learning corpus created by the function of emphasizing the learning corpus.

33. The speech recognition language model making program as claimed in claim 32, which enables the computer to execute a function that divides the learning corpus and extracts the characteristic part from each of the divided learning corpuses.

34. The speech recognition language model making program as claimed in claim 33, which enables the computer to execute the function of extracting the characteristic part from each of the divided learning corpuses according to a tf-idf value that is a criterion for extracting the characteristic part of the learning corpus.

35. The speech recognition language model making program as claimed in claim 33, which enables the computer to execute a function that extracts the part to be extracted by a unit of sentence.

36. The speech recognition language model making method as claimed in claim 33, which enables the computer to execute a function that extracts the part to be extracted by a unit of phrase.
